(19) United States
(12) Patent Application Publication
(10) Pub. No.: US 2026/0113113 A1
(43) Pub. Date: Apr. 23, 2026

(54) Spectrum Quality Indicator for Layer 0 Path Computation

(71) Applicant: Ciena Corporation, Hanover, MD (US)

(72) Inventor: Choudhury A. Al Sayeed, Stittsville (CA)

(73) Assignee: Ciena Corporation, Hanover, MD (US)

(21) Appl. No.: 18/924,539

(22) Filed: Oct. 23, 2024

(51) Int. Cl. H04B 10/079; H04J 14/02

(52) U.S. Cl. CPC H04B 10/0795; H04J 14/0212

(57) ABSTRACT

Systems and methods for a spectrum quality indicator for use in Layer 0 (optical or photonic) path computation include obtaining measured optical spectrum at an upstream location in an optical network; scaling the measured optical spectrum at a downstream location based on a plurality of components in the optical network to determine an estimated optical spectrum at the downstream location; evaluating the estimated optical spectrum to determine a spectrum quality indicator; and utilizing the spectrum quality indicator to one or more of i) block the downstream location for new capacity adds, ii) allow the downstream location for the new capacity adds, or iii) weight the upstream location in for the new capacity adds.

### FIELD OF THE DISCLOSURE

The present disclosure relates generally to optical networking. More particularly, the present disclosure relates to systems and methods for a spectrum quality indicator for use in Layer 0 (optical or photonic) path computation.

### BACKGROUND OF THE DISCLOSURE

In an optical network using amplified spontaneous emission (ASE) loading, ASE is intentionally introduced into the system to simulate real-world operating conditions for the network's optical amplifiers. ASE is the noise generated by optical amplifiers, such as erbium-doped fiber amplifiers (EDFAs), as they amplify the signal passing through them. ASE loading is used to maintain full-fill conditions to simplify network operation by ensuring consistent performance across all channels, even when the network is not fully loaded with data traffic. In scenarios where some wavelength channels are not active, ASE loading introduces controlled amounts of noise to simulate the presence of data signals on those inactive channels. This creates an artificial environment where the optical amplifiers, such as EDFAs, operate as if all channels are fully utilized. By maintaining this full-fill condition, the network avoids the complexity of fluctuating power levels that can occur with varying channel loads, which can lead to signal degradation and amplifier inefficiencies. ASE loading also helps maintain a predictable operational environment, reducing the need for dynamic adjustments in power balancing or gain control, thus making the management of multi-channel optical systems more straightforward and reliable.

### BRIEF SUMMARY OF THE DISCLOSURE

The present disclosure relates to systems and methods for a spectrum quality indicator for use in Layer 0 (optical or photonic) path computation. In an ASE-loaded system, traffic cannot be added to an optical section by simply replacing the ASE spectrum if the incoming traffic signal is too low or too high. The ASE-loaded system acts as a full-spectrum environment, allowing digital switching between ASE and traffic signals for power replacement. This ensures that spectrum control applications do not need to manage the linear and non-linear properties of the fiber transmission system, such as stimulated Raman scattering (SRS), tilt, ripple, or spectral-hole burning, which could affect other in-service traffic signals. If low signal powers are allowed in a section, they can impact the power and optical signal-to-noise ratio (OSNR) of other active channels, depending on bandwidth and spectrum location. Similarly, if the incoming signal power is too high, it can saturate downstream optical amplifiers and affect neighboring channels due to cross-phase modulation (XPM) and SRS. Multiple factors can degrade the spectrum content (either the entire spectrum or specific parts) along the transmission path, and current Layer 0 restoration methods do not account for spectrum quality during path computation.

As a result, Layer 0 restorations are often triggered blindly along ASE-loaded optical paths, without considering spectrum quality, and may be rejected by photonic controllers if the signal power falls outside allowable thresholds. This can lead to failed mission-critical Layer 0 restorations and significant delays in recovery. The goal of this disclosure is to introduce a spectrum quality indicator in the Layer 0 control plane for each degree or mux-connection, allowing the system to proactively consider spectrum quality during path computation.

In various embodiments, the present disclosure includes a method having steps, a processing device configured to implement the steps, and a non-transitory computer-readable medium storing instructions that, when executed, cause one or more processors to implement the steps. The steps include obtaining measured optical spectrum at an upstream location in an optical network; scaling the measured optical spectrum at a downstream location based on a plurality of components in the optical network to determine an estimated optical spectrum at the downstream location; evaluating the estimated optical spectrum to determine a spectrum quality indicator; and utilizing the spectrum quality indicator to one or more of i) block the downstream location for new capacity adds, ii) allow the downstream location for the new capacity adds, or iii) weight the upstream location in for the new capacity adds. The scaling includes taking the measured optical spectrum and sequentially applying expected or measured transfer functions or a combination of both for each of the plurality of components up to the downstream location.

The expected transfer functions can include a loss or gain expected or targeted across the spectrum over an optical medium or components that can be obtained from a last successful calibration process or can be set as a target, and measured transfer function include a loss or gain measurement across the spectrum over an optical medium or component. The plurality of components can include a wavelength selective switch (WSS). The scaling can include applying an expected transfer function based on a last successful calibration process with the WSS, or target transfer function set to achieve with the WSS, with a combination of measured or expected transfer function of a fiber or optical medium connecting the upstream and downstream location.

The spectrum quality indicator can be continuously updated based on the measured optical spectrum or changes to an expected or measured transfer function. The spectrum quality indicator can be determined based on drift of any of average power spectral density, spectral tilt, or presence of ripple in any discrete part of the estimated spectrum from a target spectrum on the downstream location. The optical network can include amplified spontaneous emission (ASE) loading. The steps can further include marking the downstream location as one of allowed or blocked or degraded for the new capacity adds based on the spectrum quality indicator. The steps can further include performing path computation for the new capacity adds where the weight of the downstream location is used to favor or disfavor the downstream location for the new capacity adds.

### BRIEF DESCRIPTION OF THE DRAWINGS

The present disclosure is detailed through various drawings, where like components or steps are indicated by identical reference numbers for clarity and consistency.

FIG. 1 illustrates an example Reconfigurable Optical Add/Drop Multiplexer (ROADM) with four degrees for illustrating some examples of spectrum degrade in ASE-loaded systems.

FIG. 2 illustrates an optical section for illustrating determination of a spectrum quality indicator.

FIG. 3 illustrates a flowchart of a process for a spectrum quality indicator for use in Layer 0 (optical or photonic) path computation.

### DETAILED DESCRIPTION OF THE DISCLOSURE

A spectrum quality indicator is derived by estimating the incoming spectrum for each mux input based on upstream measured spectrum and scaling it using a combination of expected and measured transfer functions over the transmission medium. This index for each input link at a section mux provides an indication of whether the spectrum is in good condition for future channel restoration, making it a valuable metric for routing and path calculation. This ensures the success of mission-critical Layer 0 restoration. If the spectrum quality is low along a particular path, it can be deprioritized in the routing index, allowing the control plane to either block that link for future restoration or use it only as a last resort when no higher-quality spectrum path is available.

By not taking spectrum quality into account ahead of time, Layer 0 restoration often presents problems, failing to accomplish mission-critical restoration requirements in achieving Layer 0 protection in customer networks. The present disclosure allows Layer 0 including Layer 0 control planes to accurately predict spectrum quality in terms of total-power, power spectral density (PSD), tilt, or ripples to understand if the spectrum on a specific band or within a band is safe for restoration on a given path end-to-end. It allows control plane to avoid the path at all costs or to use only as the last resort if no other path is available. The approach described herein is applicable in any ASE-loaded system where spectrum quality can be accurately predicted ahead of time, based on measured system data.

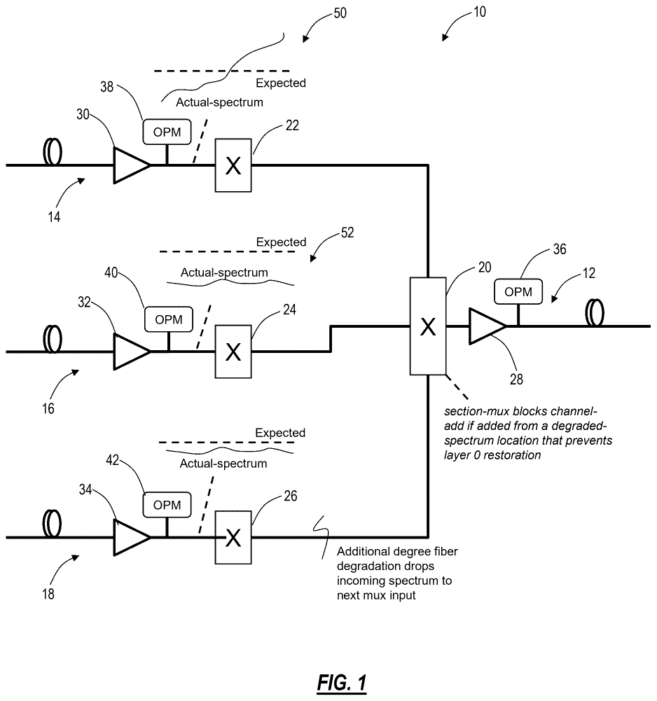

FIG. 1 illustrates an example Reconfigurable Optical Add/Drop Multiplexer (ROADM) 10 with four degrees 12, 14, 16, 18 for illustrating some examples of spectrum degrade in ASE-loaded systems. The ROADM 10 is a network element in an optical network configured to dynamically manage and route optical channels between the degrees 12, 14, 16, 18 as well as local add/drop (not shown). Unlike traditional optical add-drop multiplexers (OADMs), ROADMs allow for remote and automated reconfiguration of wavelength paths without manual intervention, enhancing network flexibility and scalability. ROADMs can selectively add, drop, or pass-through individual wavelengths, enabling efficient bandwidth utilization by adapting to changing traffic patterns and optimizing the use of available network resources. Typically, ROADMs incorporate components like wavelength selective switches (WSS) 20, 22, 24, 26, which facilitate the independent manipulation of multiple wavelengths, making them ideal for complex optical networks with dynamic and high-capacity requirements. For illustration purposes, the ROADM 10 in FIG. 1 is illustrated in a unidirectional configuration, where the degrees 14, 16, 18 are shown providing spectrum to the degree 12. Of course, a practical embodiment includes additional components for bidirectional communication.

The WSSs 20, 22, 24, 26 provide the selective routing, blocking, or switching of individual wavelengths or spectrum across fiber links by utilizing technologies like liquid crystal on silicon (LCoS) or microelectromechanical systems (MEMS). This capability allows for the dynamic management of optical channels, providing flexibility in network configuration and optimizing bandwidth utilization across Dense Wavelength Division Multiplexing (DWDM) systems. Additionally, the ROADM 10 includes optical amplifiers 28, 30, 32, 34, such as EDFAs, and optical power monitors (OPMs) 36, 38, 40, 42. The optical amplifiers 28, 30, 32, 34 amplify optical signals directly a fiber without needing to convert them into electrical signals, effectively boosting signal strength over long distances. The OPMs 36, 38, 40, 42 non-invasively monitor the signal power by using taps to extract a small portion of optical power without interrupting or degrading the main signal flow. This enables real-time measurement and assessment of the optical power across various channels within the ROADM 10, allowing for the detection of signal degradation or power imbalances.

The ROADM 10 is an ASE-loaded system. ASE loading is used to simulate full channel capacity in instances where not all wavelengths or spectrum are actively transmitting data. ASE noise such as generated by the optical amplifiers 28, 30, 32, 34 or another ASE source, is deliberately injected into the degrees 12, 14, 16, 18 to occupy unused wavelength channels or spectrum. The ASE is added at the egress of a degree, e.g., here at the degree 12.The degrees 14, 16, 18 would have had ASE added at an adjacent ROADM (not shown). ASE loading helps maintain consistent operational conditions in optical amplifiers, as they perform optimally when handling a uniform load across all channels. ASE loading ensures that the amplifier gain remains stable and prevents issues related to gain tilt, which can negatively affect signal quality on active channels. By simulating a fully loaded network environment, ASE loading helps maintain consistent performance, making it particularly useful in testing and maintaining high-capacity DWDM systems.

The degrees 14, 16, 18 are used to illustrate three example use cases of spectrum degrade in the ROADM 10 in an ASE loaded system. In a first use case, illustrated in the degree 14 to the degree 12, optical spectrum on the degree 14 from an upstream section can be degraded from a last calibrated snapshot or expectation due to an upstream fault or lack of compensation (out of dynamic range). The optical spectrum can become degraded if an upstream fault occurs or if the system's dynamic range is insufficient to compensate for signal variations. When an upstream fault, such as a fiber break or component failure, it can lead to an uneven distribution of ASE noise and signal power across the optical spectrum. This imbalance can propagate downstream, causing variations in signal strength and potentially overwhelming the dynamic range of optical amplifiers, which may struggle to adequately adjust gain across affected channels. As a result, the optical amplifiers may introduce gain tilt or fail to maintain proper power levels, leading to signal degradation, increased noise, and diminished overall system performance. In cases where the dynamic range cannot compensate effectively, the integrity of active data channels can be compromised. A graph 50 illustrates the optical spectrum coming from the degree 14 based on this first use case. Such degrade could be a linear-drop or linear-rise so that capacity adds on any part of the optical spectrum can be impacted on downstream locations. Also, such degrade could be due to a heavy-tilt, where certain part of the optical spectrum can be impacted due to substantial overshoot or undershoot.

In a second use case, illustrated in the degree 16 to the degree 12, the degree fiber connection between a demultiplexer (demux) and multiplexer (mux) can be degraded from expectation or a last-known baseline. This will further degrade the incoming spectrum at the section-mux input. A graph 52 illustrates the optical spectrum coming from the degree 16 based on this second use case. The degree fiber connection between a demultiplexer (demux) and multiplexer (mux) can degrade from the expected or last-known baseline performance due to various factors that impact signal quality. This connection, which is responsible for routing optical signals between different network nodes or within the ROADM itself, can suffer from increased attenuation or insertion loss over time. Such degradation may arise from physical factors like fiber aging, micro-bending, or connector contamination, as well as from optical component misalignment. In an ASE-loaded system, these issues are particularly critical because they affect the uniformity and stability of ASE noise and optical signals being passed through. When the power levels deviate from baseline expectations, the compensatory mechanisms of the system, such as optical amplifiers, may be unable to balance the changes adequately due to their finite dynamic range. This can lead to uneven signal distribution and degradation in signal-to-noise ratio (SNR) across channels, ultimately impacting the system's ability to maintain optimal performance and reliable data transmission.

In a third use case, illustrated in the degree 18 to the degree 12, it is possible to have a combination of first and second use case, that eventually deteriorates incoming spectrum at a section-mux input and prevents channel-add at the time of restoration. A graph 54 illustrates the optical spectrum coming from the degree 18 based on this third use case. A section multiplexer, or section mux, in the ROADM 10, is a device used to manage the aggregation and routing of optical signals within specific sections or segments of the network. The section mux selectively combines multiple wavelengths from different channels into a single optical fiber, which then transmits these combined signals to the next network segment or node. This functionality is essential for efficiently managing traffic flow across the network, where numerous wavelengths are transmitted simultaneously over the same fiber. Section muxes play a crucial role in optimizing the capacity and flexibility of ROADMs by allowing for granular control over which wavelengths are routed, added, or dropped at various points in the network. This capability supports dynamic network configurations and improves the ability to scale and adapt to changing traffic patterns in metro and long-haul optical networks. For example, in the ROADM 10, the section muxes can be any of the WSSs 20, 22, 24, 26.

Again, the purpose of ASE loading is to simplify the channel add/delete process, namely switching traffic-bearing channels for ASE loading and vice versa. Existing control planes blindly restore to a path without knowing if a channel add would be blocked due to low spectrum-quality. Existing control plane only figures out after a restoration attempt fails by local node level controllers and then retries on a new path, again without knowing what the outcome would be. Blindly adding or switching channels in an environment utilizing ASE-loading can be problematic due to potential spectrum degradation. In ASE-loaded systems, all channels, whether actively transmitting data or not, are filled with ASE noise to simulate full capacity and maintain stable amplifier operation. However, when the optical spectrum degrades due to upstream faults or insufficient dynamic range, the power levels across wavelengths become imbalanced, affecting signal quality.

If new channels are added or existing ones are switched without assessing current spectrum conditions, these changes can exacerbate existing issues like gain tilt, noise, or crosstalk. The amplifiers may not be able to adjust accurately to sudden power fluctuations, leading to inadequate amplification or overcompensation on specific wavelengths. This could result in degraded SNR on both the new and existing channels, impairing data transmission quality. Therefore, it is essential to monitor the spectrum conditions before adding or switching channels to avoid amplifying or introducing errors across the network. By doing so, network operators can ensure that each channel maintains optimal performance, supporting reliable and high-quality communication across the DWDM system.

To solve the problem of blindly adding channels, the present disclosure proposes a spectrum-quality-indicator that is maintained and used to determine whether or not to perform a channel add. By taking spectrum quality into account ahead of time, layer 0 mesh restoration can accomplish mission-critical restoration. The method allows control plane solutions to accurately predict spectrum-quality in terms of total-power, PSD, tilt, or ripples to understand if the spectrum on a specific band or withing a band is safe to be used for restoration on a given path end-to-end. It allows control plane to avoid the path at all costs or to use only as the last resort if no other path is available.

The spectrum quality indicator for each section-mux input is based on an estimated spectrum view from incoming measured spectrum, e.g., based on measurements at the OPMs 38, 40, 42, scaled at each mux input The estimated spectrum view is generated based on the measurements from a first available optical spectrum monitor (i.e., OPM) and then scaled at mux input with a combination of measured and expected losses between the spectrum-monitor and the mux-input. For example, if the OPM is located at an upstream section-demux input (or pre-amplifier output), the estimated spectrum view is generated using a target/expected spectrum profile delta over the demux and measured physical fiber loss over the degree fiber.

The spectrum quality indicator can be derived per optical-transmission band (such as C-band or L-band) based on measured spectrum delta from previously calibrated expectation in terms of average PSD (power spectral density), spectral-tilt, and/or presence of ripple or drift in any discrete part of the optical spectrum. The spectrum quality indicator is based on measurements at some points and calculations to bring the measurements forward, and thus is an estimate. That is, the spectrum quality indicator is derived based on pre-estimated incoming spectrum for each mux input, from upstream measured spectrum, scaled using a combination of expected and measured transfer function over the transmission medium. In an embodiment, the spectrum quality indicator is for any input into a WSS. The spectrum quality indicator indicates if the optical spectrum is in good shape, i.e., condition, for future channel restoration, marking it for routing, path-calculation to ensure success for mission critical layer 0 restoration.

Based on the pre-estimated quality of the spectrum, the restoration can be blocked from an upstream degree path either for a given-band (C/L) or for both bands, or only for a given part of a spectrum in a given band (C/L). In other words, with this approach, the layer 0 control plane not only takes spectrum availability and link-budget considerations along a route, but also will take pre-estimated spectrum quality on each mux-input into account, that will ensure successful mission critical restoration along the path. Of course, the spectrum quality indicator can be used outside of layer 0 control planes, such as with network elements themselves using this to allow or block capacity adds. Low quality optical spectrum in path can be moved lower in a routing index so that control plane can either block the link for future restoration or use it only as the last resort when no other good quality spectrum path is available.

The spectrum quality indicator is some value indicating the quality of this link and this value can be used to (1) allow/block the link for capacity adds, (2) order the link for path computation for capacity adds, (3) mark the link as degraded where it is only used as a last resort for capacity adds, etc. For example, to allow/block the link, the spectrum quality indicator can be pass/fail, good/bad, allow/block, etc. For ordering, the spectrum quality indicator can be some numerical value or ordering (e.g., A, B, C, etc.) that enables ranking the link. Here, a path computation element (PCE) or the like performing path computation can use the spectrum quality indicator to order prospective paths, e.g., using the best paths first. In an embodiment, the allow/block and order approach can be combined—do not use this link unless absolutely necessary. Marking the link as degraded includes only using the link for a capacity add if there is no other alternative.

As described herein, capacity adds on a link relates to either adding a new channel, restoring a channel from another link, or adding more traffic to an existing channel. For example, capacity adds could refer to add adding more traffic on an already existing channel. For example, a channel width is 200 GHz, and carrying 1000 Gbps traffic, but the modem can be programmed to send more traffic such as 1600 Gbps over the same 200 GHz channel. However, if the quality of the spectrum is degraded, then that may prevent adding more capacity even to an existing channel. Those skilled in the art will recognize capacity adds means doing something on a link to add something.

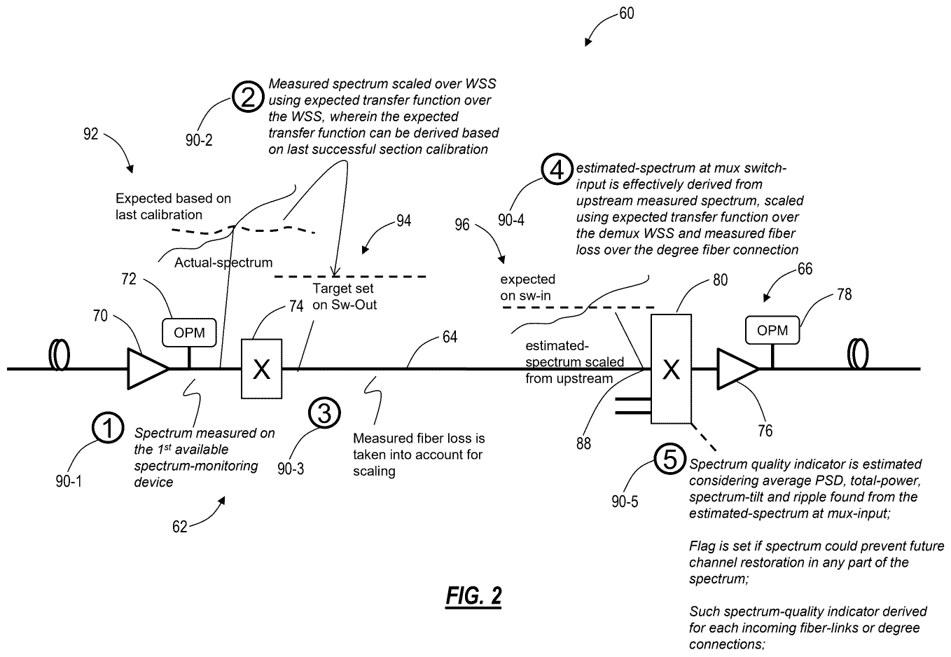

FIG. 2 illustrates an optical section 60 for illustrating determination of a spectrum quality indicator. The optical section 60 includes an upstream degree 62, a fiber span 64, and a downstream degree 66. The upstream degree 62 includes an optical amplifier 70, an OPM 72, and a WSS 74. The downstream degree 66 includes an optical amplifier 76, an OPM 78, and a WSS 80. The downstream degree 66 is connected to the upstream degree 62 via the fiber span 64. Those skilled in the art will appreciate this is a simplified example for illustration purposes and more complex network architectures are contemplated, e.g., multiple spans with intermediate optical amplifiers. Of note, the spectrum quality indicator is determined from a downstream mux (WSS) to an upstream mux (WSS), i.e., on an optical section basis. The term link refers to a fiber path in the optical section, and each link can have a current value for the spectrum quality indicator.

An example is now described with reference to FIG. 2 for determining the spectrum quality indicator. In this example, the determination is the spectrum quality indicator at a port 88 on the WSS 80. At the upstream degree 62, the optical spectrum is measured at the OPM 72, after the amplifier 70 (step 90-1). The OPM 72 is a first available spectrum-monitoring device, and a graph 92 shows the actual optical spectrum versus the expected optical spectrum based on the last calibration. This is a measured value which is scaled over the WSS 74 using an expected transfer function (step 90-2). The expected transfer function is derived based on the last successful section calibration, and the resulting derived spectrum is shown in a graph 94. Here, the expected transfer function is applied to the measured value of the optical spectrum from the OPM 72.

The expected transfer function of the optical spectrum through the WSS 70 describes how the WSS 70 impacts the amplitude and phase of optical signals as they pass through. The WSS 70 provides dynamic routing and power adjustment of individual wavelengths across multiple output ports. The transfer function characterizes how each wavelength channel is attenuated, routed, and possibly phase-shifted, with critical components such as amplitude and phase response, spectral filtering characteristics, and routing functionality. The amplitude transfer function determines the output power of each wavelength based on the WSS's control settings, which allows for signal power balancing across channels to avoid issues like cross-talk and channel imbalance in downstream components. The phase response is equally important in coherent systems, as phase adjustments maintain signal coherence and minimize interference. The WSS's transfer function also includes spectral filtering effects, determining the shape and sharpness of passbands for each wavelength. This affects bandwidth and performance, impacting how closely wavelengths can be spaced without risking signal degradation. Additionally, the WSS provides routing and switching capabilities, allowing specific wavelengths to be directed to designated output ports. The transfer function takes into account the losses introduced by these switching mechanisms, as well as how switching affects signal quality at each output.

Practical considerations for the transfer function include insertion losses, polarization-dependent losses, and channel isolation. Ideal transfer functions aim for high isolation to minimize cross-talk. Since WSS units are dynamically adjustable, the transfer function will vary based on active configurations, such as which wavelengths are routed to which ports and the power levels required for each channel. Overall, the expected transfer function of a WSS is crucial for understanding its impact on network performance and signal integrity in optical communications. The present disclosure uses characteristics from the last successful section calibration to apply the transfer function, i.e., why it is called an expected transfer function.

Next, measured fiber loss is taken into account (step 90-3). Here, the fiber loss of the fiber span 64 is further applied to the spectrum from the graph 94 and is shown in a graph 96. The fiber loss can be measured using components in the optical network, but also can be computed such as using distance and attenuation over that distance. At the port 88, the estimated spectrum is effectively derived from upstream measured spectrum, scaled using expected transfer function over the demux WSS 74 and measured fiber loss over the degree fiber connection (step 90-4). The spectrum quality indicator is estimated considering average PSD, total power, spectrum tilt, and ripple found from the estimated spectrum at the port 80 (step 90-5). A flag can be set if spectrum could prevent future channel restoration in any part of the spectrum, and such spectrum quality indicator is derived for each incoming fiber links or degree connections. That is, while FIG. 2 shows one spectrum quality indicator for the port 80, those skilled in the art will recognize each incoming fiber link or degree connection can have its own spectrum quality indicator determined as described above.

Existing systems perform line system modeling using amplifier gain, span loss setting, factory calibrated loss values, four wave mixing (FWM) modeling, etc. for SNR estimates along the path based on existing channel fill. The problems with this data include:
(1) It relies on current channel loading along different paths.
(2) With new restoration coming in, those actual data or estimates will change, but this approach cannot take care of that right before restoration.
(3) For a L0 control plan (in-skin or out of skin), it's always going to be a “reactive” action. In-skin means operating on a network element (ROADM) and out of skin means on an external device, e.g., management system.

The present disclosure provides a “proactive” signal for the control plane to avoid a spectrum portion in a path if degraded, and it is achievable due to “full fill” ASE management. Stated differently, the modeling approach above requires computation power and time, which is not available immediately. The spectrum quality indicator is always available based on taking a current measurement and scaling factors for adjustment. By having this indicator available in real time, it can be used to make immediate decisions—block a route, allow a route, disfavor a route, etc.

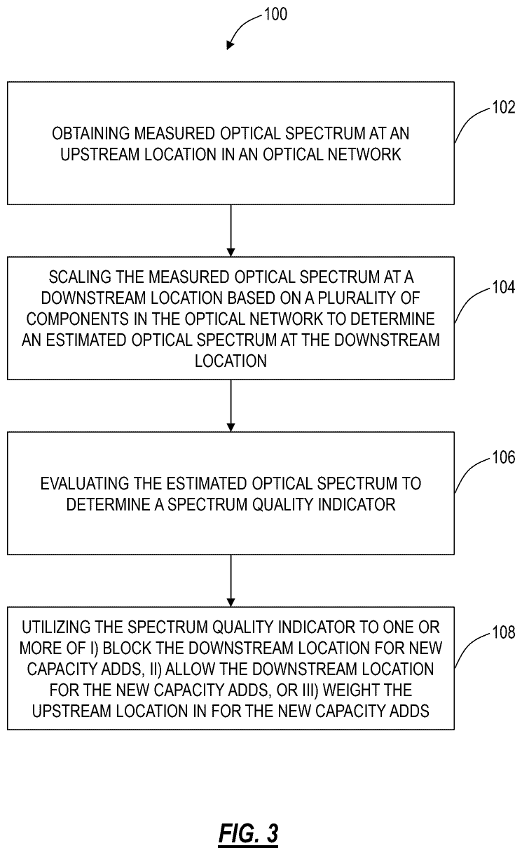

FIG. 3 illustrates a flowchart of a process 100 for a spectrum quality indicator for use in Layer 0 (optical or photonic) path computation. The process 100 contemplates implementation as a method having steps, via an apparatus configured to implement the steps, and as a non-transitory computer-readable medium storing instructions that, when executed, cause one or more processors to implement the steps. The apparatus can be a network element such as a controller or control module included therein. The network element can be a ROADM node. In another embodiment, the apparatus can be an off box device such as a management system, software defined networking (SDN) controller, etc.

The steps include obtaining measured optical spectrum at an upstream location in an optical network (step 102); scaling the measured optical spectrum at a downstream location based on a plurality of components in the optical network to determine an estimated optical spectrum at the downstream location (step 104); evaluating the estimated optical spectrum to determine a spectrum quality indicator (step 106); and utilizing the spectrum quality indicator to one or more of i) block the downstream location for new capacity adds, ii) allow the downstream location for the new capacity adds, or iii) weight the upstream location in for the new capacity adds (step 108).

The scaling includes taking the measured optical spectrum and sequentially applying expected or measured transfer functions or a combination of both for each of the plurality of components up to the downstream location. The expected transfer functions can include a loss or gain expected or targeted across the spectrum over an optical medium or components that can be obtained from a last successful calibration process or can be set as a target, and measured transfer function include a loss or gain measurement across the spectrum over an optical medium or component.

In an embodiment, the plurality of components include a wavelength selective switch (WSS). The scaling can include applying an expected transfer function based on a last successful calibration process with the WSS, or target transfer function set to achieve with the WSS, with a combination of measured or expected transfer function of the fiber or optical medium connecting the upstream and downstream location. The spectrum quality indicator can be continuously updated based on the measured optical spectrum or changes to an expected or measured transfer function. The spectrum quality indicator can be determined based on the drift of any of average power spectral density, spectral tilt, or presence of ripple in any discrete part of the estimated spectrum from a target spectrum on the downstream location.

The steps can further include marking the downstream location as one of allowed or blocked or degraded for the new capacity adds based on the spectrum quality indicator. A link marked as blocked is unavailable for a new capacity add whereas a degraded link is available, but only as a last resort. Last resort can mean the link can only be used for restoration of a channel where there is no alternative. The steps can further include performing path computation for the new capacity adds where the weight of the downstream location is used to favor or disfavor the downstream location for the new channel adds.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method comprising steps of:
obtaining measured optical spectrum at an upstream location in an optical network;
scaling the measured optical spectrum at a downstream location based on a plurality of components in the optical network to determine an estimated optical spectrum at the downstream location;
evaluating the estimated optical spectrum to determine a spectrum quality indicator; and
utilizing the spectrum quality indicator to one or more of i) block the downstream location for new capacity adds, ii) allow the downstream location for the new capacity adds, or iii) weight the upstream location in for the new capacity adds.

2. The method of claim 1, wherein the scaling includes taking the measured optical spectrum and sequentially applying expected or measured transfer functions or a combination of both for each of the plurality of components up to the downstream location.

3. The method of claim 2, wherein the expected transfer functions include a loss or gain expected or targeted across the spectrum over an optical medium or components that can be obtained from a last successful calibration process or can be set as a target, and measured transfer function include a loss or gain measurement across the spectrum over an optical medium or component.

4. The method of claim 1, wherein the plurality of components include a wavelength selective switch (WSS).

5. The method of claim 4, wherein the scaling includes applying an expected transfer function based on a last successful calibration process with the WSS, or target transfer function set to achieve with the WSS, with a combination of measured or expected transfer function of a fiber or optical medium connecting the upstream and downstream location.

6. The method of claim 1, wherein the spectrum quality indicator is continuously updated based on the measured optical spectrum or changes to an expected or measured transfer function.

7. The method of claim 1, wherein the spectrum quality indicator is determined based on drift of any of average power spectral density, spectral tilt, or presence of ripple in any discrete part of the estimated spectrum from a target spectrum on the downstream location.

8. The method of claim 1, wherein the optical network includes amplified spontaneous emission (ASE) loading.

9. The method of claim 1, wherein the steps further include
marking the downstream location as one of allowed or blocked or degraded for the new capacity adds based on the spectrum quality indicator.

10. The method of claim 1, wherein the steps further include
performing path computation for the new capacity adds where the weight of the downstream location is used to favor or disfavor the downstream location for the new capacity adds.

11. A non-transitory computer-readable medium comprising instructions that, when executed, cause one or more processors to implement steps of:
obtaining measured optical spectrum at an upstream location in an optical network;
scaling the measured optical spectrum at a downstream location based on a plurality of components in the optical network to determine an estimated optical spectrum at the downstream location;
evaluating the estimated optical spectrum to determine a spectrum quality indicator; and
utilizing the spectrum quality indicator to one or more of i) block the downstream location for new capacity adds, ii) allow the downstream location for the new capacity adds, or iii) weight the upstream location in for the new capacity adds.

12. The non-transitory computer-readable medium of claim 11, wherein the scaling includes taking the measured optical spectrum and sequentially applying expected or measured transfer functions or a combination of both for each of the plurality of components up to the downstream location.

13. The non-transitory computer-readable medium of claim 12, wherein the expected transfer functions include a loss or gain expected or targeted across the spectrum over an optical medium or components that can be obtained from a last successful calibration process or can be set as a target, and measured transfer function include a loss or gain measurement across the spectrum over an optical medium or component.

14. The non-transitory computer-readable medium of claim 11, wherein the plurality of components include a wavelength selective switch (WSS).

15. The non-transitory computer-readable medium of claim 14, wherein the scaling includes applying an expected transfer function based on a last successful calibration process with the WSS, or target transfer function set to achieve with the WSS, with a combination of measured or expected transfer function of a fiber or optical medium connecting the upstream and downstream location.

16. The non-transitory computer-readable medium of claim 11, wherein the spectrum quality indicator is continuously updated based on the measured optical spectrum or changes to an expected or measured transfer function.

17. The non-transitory computer-readable medium of claim 11, wherein the spectrum quality indicator is determined based on drift of any of average power spectral density, spectral tilt, or presence of ripple in any discrete part of the estimated spectrum from a target spectrum on the downstream location.

18. The non-transitory computer-readable medium of claim 11, wherein the optical network includes amplified spontaneous emission (ASE) loading.

19. The non-transitory computer-readable medium of claim 11, wherein the steps further include
marking the downstream location as one of allowed or blocked or degraded for the new capacity adds based on the spectrum quality indicator.

20. The non-transitory computer-readable medium of claim 11, wherein the steps further include
performing path computation for the new capacity adds where the weight of the downstream location is used to favor or disfavor the downstream location for the new capacity adds.
